(19) United States
(12) Patent Application Publication
(10) Pub. No.: US 2025/0330502 A1
(43) Pub. Date: Oct. 23, 2025

(54) TRANSFERRING AN ACTIVE VOICE COMMUNICATION

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 19/176,864

(22) Filed: Apr. 11, 2025

Related U.S. Application Data
(60) Provisional application No. 63/637,078, filed on Apr. 22, 2024.

(51) Int. Cl. H04L 65/1094; H04L 65/1069; H04W 88/04

(52) U.S. Cl. CPC H04L 65/1094; H04L 65/1069; H04W 88/04

(57) ABSTRACT

A system and method for providing a phone call audio transfer feature. When a primary device and an endpoint device are engaged in an active voice communication session and the call transfer feature is triggered, a communication link (e.g., Bluetooth® connection, peer-to-peer connection over a local network, or a server-moderated connection via a conferencing application) is established between the primary device and a selected secondary device. The microphone and speaker of the primary device may be deactivated during the active voice communication session and the microphone and speaker of the secondary device may be activated. Via the established communication link, audio data received from the endpoint device is transmitted to the secondary device through the communication link and audio data captured by the microphone of the secondary device is transmitted to the primary device through the communication link, which then transmits the captured audio data to the endpoint device.

### CROSS-REFERENCE TO RELATED APPLICATIONS

This application claims the benefit of U.S. Provisional Application No. 63/637,078 filed Apr. 22, 2024, entitled “Transferring an Active Voice Communication,” which is incorporated herein by reference in its entirety.

### BACKGROUND

Aspects of the present disclosure relate to a mobile communication device and a method of transferring audio of an active phone call on the mobile communication device to another mobile communication device. For a variety of reasons, such as due to responsibilities of operating a vehicle, to engage with other features of a mobile communication device, or simply a desire to delegate a conversation to someone else, a user of the mobile communication device may wish to transfer an active voice communication to another user of another mobile communication device.

It is with these observations in mind, among others, that aspects of the present disclosure were conceived.

### SUMMARY

The present disclosure describes a system and method for transferring audio of an active phone call from a first mobile communication device to a secondary mobile communication device. When a primary device is on a phone call with an endpoint device and a call transfer feature is triggered, a communication link is established between the primary device and a selected secondary device. The communication link may be a Bluetooth® connection, peer-to-peer connection over a local network, or a server-moderated connection via a conferencing application. The microphone and speaker of the primary device may be deactivated from the phone call and the microphone and speaker of the secondary device may be activated. Via the established communication link, audio data received from the endpoint device is transmitted to the secondary device through the communication link and audio data captured by the microphone of the secondary device is transmitted to the primary device through the communication link, which then transmits the captured audio data to the endpoint device.

One aspect of the present disclosure includes a system, comprising: at least one processing unit; and memory, operatively connected to the at least one processing unit and storing instructions that, when executed by the at least one processing unit, cause the system to: on a primary mobile communication device, establish an active voice communication session with an endpoint communication device via a first communication link; receive a selection, during the active voice communication session, to transfer audio of the active voice communication session to a secondary mobile communication device; provide a call transfer request to the secondary mobile communication device; receive an indication of approval of the call transfer request; establish a second communication link between the primary mobile communication device and the secondary mobile communication device; deactivate, during the active voice communication session, a microphone and speaker for the active voice communication session on the primary mobile communication device; relay, by the primary mobile communication device, audio data received during the active voice communication session from the endpoint communication device via the first communication link to the secondary mobile communication device via the second communication link; and relay, by the primary mobile communication device, audio data received during the active voice communication session from the secondary mobile communication device via the second communication link to the endpoint mobile device via the first communication link.

Another aspect of the present disclosure includes a method, comprising: on a primary mobile communication device, establishing an active voice communication session with an endpoint communication device via a first communication link; receiving a selection, during the active voice communication session, to transfer audio of the active voice communication session to a secondary mobile communication device; providing a call transfer request to the secondary mobile communication device; receiving an indication of approval of the call transfer request; establishing a second communication link between the primary mobile communication device and the secondary mobile communication device; deactivating, during the active voice communication session, a microphone and speaker for the active voice communication session on the primary mobile communication device; relaying, by the primary mobile communication device, audio data received during the active voice communication session from the endpoint communication device via the first communication link to the secondary mobile communication device via the second communication link; and relaying, by the primary mobile communication device, audio data received during the active voice communication session from the secondary mobile communication device via the second communication link to the endpoint mobile device via the first communication link.

Another aspect of the present disclosure includes a non-transitory computer-readable medium, storing instructions that, when executed by a computing device, cause the computing device to: establish an active voice communication session between a primary mobile communication device and an endpoint communication device via a first communication link; receive a selection, during the active voice communication session, to transfer audio of the active voice communication session to a secondary mobile communication device; provide a call transfer request to the secondary mobile communication device; receive an indication of approval of the call transfer request; establish a second communication link between the primary mobile communication device and the secondary mobile communication device; deactivate, during the active voice communication session, a microphone and speaker for the phone call on the primary mobile communication device; relay, by the primary mobile communication device, audio data received during the active voice communication session from the endpoint communication device via the first communication link to the secondary mobile communication device via the second communication link; and relay, by the primary mobile communication device, audio data received during the active voice communication session from the secondary mobile communication device via the second communication link to the endpoint mobile device via the first communication link.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a representation of a communications system in which transferring audio of an active phone call may be implemented according to an example.

FIG. 2 is a representation of a communications system in which transferring audio of an active phone call may be implemented according to another example.

FIG. 3A is an illustration of an example user interface that may be provided for transferring audio of an active phone call according to an example.

FIG. 3B is an illustration of an example user interface that may be provided for transferring audio of an active phone call according to another example.

FIG. 3C is an illustration of an example user interface that may be provided for transferring audio of an active phone call according to another example.

FIG. 3D is an illustration of an example user interface that may be provided for transferring audio of an active phone call according to another example.

FIG. 3E is an illustration of an example user interface that may be provided for transferring audio of an active phone call according to another example.

FIG. 4 is a flowchart illustrating operations of a method for transferring audio of an active phone call according to an example.

FIG. 5 is a block diagram of a computing device with which one or more aspects of the disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Aspects of the present disclosure provide a system and method for transferring audio of an active phone call to a secondary device. As an illustrative example, a user may make or receive a phone call on a first device (e.g., a mobile phone or other mobile communication device) with a user of an endpoint device. At some point during the phone call, the user of the first device may desire to transfer audio of the phone call to the secondary device (e.g., another mobile phone or other mobile communication device). Thus, a call transfer feature is provided that allows the first device to establish a communication link with the secondary device. In examples, the communication link is established upon receiving an indication of acceptance from the secondary device to transfer the phone call. The communication link may be a Bluetooth connection, peer-to-peer connection over a local network, or a connection via a conferencing application. The microphone and speaker of the first device may be deactivated from the phone call and the microphone and speaker of the secondary device may be activated. Via the established communication link, audio data received from the endpoint device is transmitted to the secondary device through the communication link. Additionally, audio data captured by the microphone of the secondary device is transmitted to the first device through the communication link, which then transmits the captured audio data to the endpoint device. As a result, the user may be able to transfer the phone call to another device without ending the call. The primary device may then be used to perform one or more other tasks for the user, as desired.

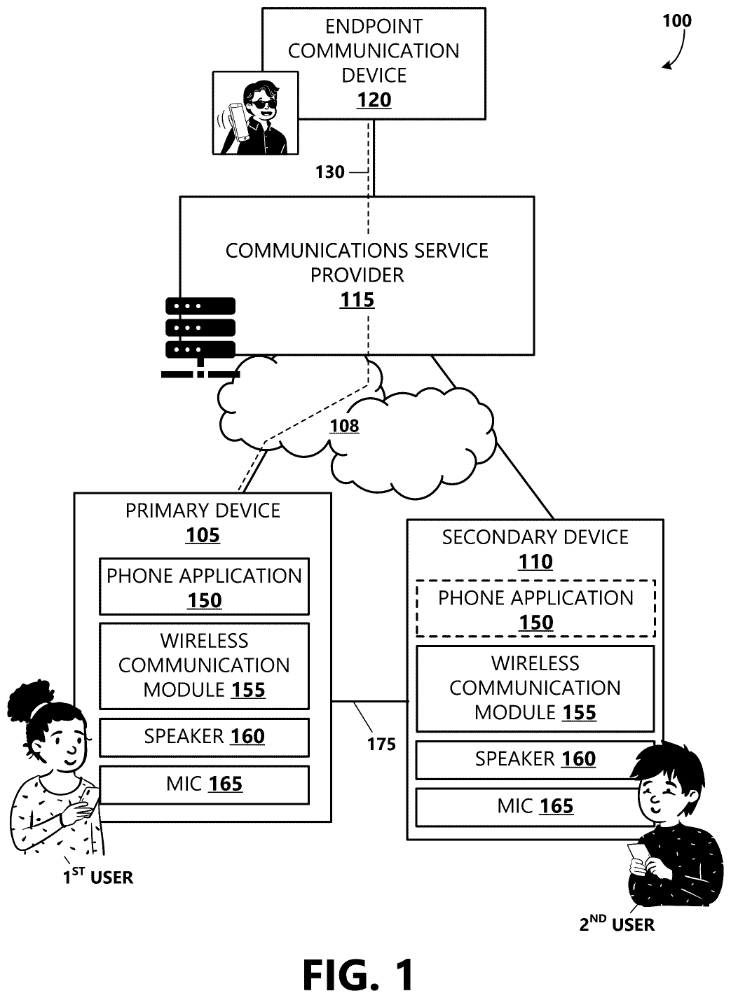

FIG. 1 is a representation of a communications system 100 in accordance with an illustrative aspect. The communications system 100 includes various elements used for wireless and wired communications over a network or a combination of networks (herein referred to as network 108). In examples, different elements and components of the communications system 100 communicate using wireless communications, such as cellular networks (e.g., 4G, LTE, or 5G), Wi-Fi networks, satellite connections, Bluetooth®, near-field communication (NFC), etc., and/or hardwired connections, such as fiber optics, T1, cable, DSL, high-speed trunks, and/or telephone lines. The communications system 100 includes a first mobile communication device (herein referred to as primary device 105) communicatively connected to an endpoint communication device 120 via an active voice communication session 130. In examples, voice communication session 130 may alternately be referred to herein as a phone call 130. The voice communication session 130 may be established in a variety of manners (e.g., by the primary device as a caller or callee). As used herein, “establish an active voice communication session” may comprise participating in a voice communication session over one or more analog or digital communication systems, including wired or wireless communications networks, connections, or links. A voice communication session is considered “active” when an audio exchange between endpoints has been initiated, as opposed to during a call-setup phase.

The communications system 100 further includes a second mobile communication device (herein referred to as secondary device 110) to which the primary device 105 transfers audio of the active phone call 130 via a call transfer feature. The primary device 105 and secondary device 110 may include a smartphone, tablet, laptop, wearable device, Internet of Things (IoT) device, or other type of mobile communication device operative to communicate on the one or more network(s) 108 using communications protocols, such as time division multiple access (TDMA), code division multiple access (CDMA), global systems for mobile (GSM) communications, personal communications systems (PCS), WLAN, WiMAX, or other cellular and data communications protocols and standards. In an example, the primary device 105 is associated with a subscriber account of a communications service provider 115, where the communications service provider 115 is a trusted entity responsible for managing mobile network services over the network(s) 108. A subscriber is subscribed to receive communications services (e.g., calls, texts, and/or data) from the communications service provider 115 and has a subscriber account with the communications service provider 115. The communications service provider 115 may include a single communications service provider or multiple communications services providers. The subscriber may be a primary or a secondary subscriber of a service plan on the subscriber account. For instance, a subscriber account may include multiple subscribers of multiple service plans. In some examples, the secondary device 110 is associated with the same subscriber account as the primary device 105, another account with the same communications service provider 115, or an account with another communications service provider. In other examples, the secondary device 110 is not associated with an active subscriber account with any communications service provider.

According to an aspect, the primary device 105 and the secondary device 110 include a wireless communication module 155. Wireless communication module 155 may comprise hardware and software/firmware to enable wireless communication according to one or more protocols. In some implementations, the wireless communication module 155 is a Bluetooth module that enables short-range data exchange between the mobile device and other wireless communication-enabled (e.g., Bluetooth-enabled devices), where the wireless communication module 155 uses radio frequency technology to establish a connection, allowing for the transfer of various types of data, such as audio, files, and control signals. In other implementations, the wireless communication module 155 is a wireless network interface card (WNIC) for enabling Wi-Fi communications with an access point connected to the network 108. In yet other implementations, the wireless communication module 155 is a cellular network module for enabling cellular data communication. Other types of wireless communication modules 155 are contemplated.

A first user of the primary device 105 and a second user of the secondary device 110 may interact or send and receive data, information, and commands through the primary device 105 and the secondary device 110, respectively. In particular, a phone application 150 operating on the primary device 105 may be used to make or receive the active phone call 130 with the endpoint communication device 120. The endpoint communication device 120 may be another mobile device, a landline phone, a Voice over Internet Protocol (VOIP) phone, a satellite phone, a wearable device, or other type of communication device. In some examples, the phone application 150 is a software application preinstalled on the primary device 105. In other examples, the phone application 150 is a third-party software application selectively installed on the primary device 105. In some implementations, the secondary device 110 also includes an instance of the phone application 150.

According to an aspect, the phone application 150 includes a call transfer feature to transfer audio of a phone call to another device, via a wireless connection (e.g., a Bluetooth connection, a LAN connection, etc.) using the wireless communication module 155. In examples, the phone application 150 presents a selectable call transfer option to trigger the call transfer feature. The call transfer option may be displayed in a user interface on a screen of the primary device 105. In some examples, the call transfer option may be presented with other call control options by the phone application 150. In other examples, the call transfer option may be presented in association with a contact in a contacts list of a contacts application integrated or in communication with the phone application 150. In other examples, the call transfer option is triggered by the secondary device 110 via a near-field communication (NFC) signal or other type of trigger. In other examples, the call transfer option is associated with a physical button on the primary device 105. In yet other examples, the call transfer option is associated with a voice command, gesture, or other user-selectable option. In further examples, various sub-options are presented on the primary device 105. For instance, the sub-options may correspond to different connection options (e.g., via Bluetooth, via Wi-Fi, via another application).

In some implementations, when the call transfer feature is triggered, one or more devices to transfer the phone call 130 to are identified and presented as options from which the first user may select. For instance, the secondary device 110 may be presented as a secondary device option to the first user. When the option corresponding to the secondary device 110 is selected, a call transfer request may be transmitted to the secondary device 110. In examples, the secondary device 110 is within wireless communication range of the primary device 105 and/or connected to a same LAN to which the primary device 105 is connected. The call transfer request may be transmitted via various types of connection requests, such as Bluetooth, peer-to-peer, NFC, a conference call invitation, or another type of connection method.

In some implementations, the secondary device options correspond to devices discovered within wireless communication range of the primary device 105. In some examples, discovered devices may include a device previously paired and connected with the primary device 105 and/or a device in discovery mode that allows the device to be detected by a host device (e.g., the primary device 105). In other implementations, the secondary device options correspond to devices in the first user's contacts list. In other implementations, the secondary device options correspond to contacts designated for the call transfer feature, such as contacts in a call transfer list or a particular contacts list category (e.g., family members, frequently called contacts, favorite contacts, call history). In other implementations, the first user may otherwise select (e.g., input) a secondary device option for transferring audio of the phone call 130.

In some examples, when a call transfer request is transmitted to the selected secondary device 110, a call transfer request notification is presented to the second user by the secondary device 110. In some implementations, a setting on the secondary device 110 allows the second user to opt in to and/or opt out of receiving call transfer request notifications (e.g., from anyone or from certain contacts). The call transfer request notification may include an “accept” option, which when selected, causes a wireless communication channel 175 to be established between the primary device 105 and the secondary device 110 and for audio functionality of the phone call 130 to be transferred to the secondary device 110. In examples, phone call audio functionality includes receiving audio data from an endpoint device during a phone call and playing it on a speaker 160 of the recipient's device and capturing audio through the device's microphone 165, encoding it into a digital format, and transmitting it over a communication channel. Thus, when phone call audio functionality (also referred to generally as “phone call audio”) is transferred from the primary device 105 to the secondary device 110, audio data received from the endpoint communication device 120 of the phone call 130 may be rerouted to the secondary device 110 and played on a speaker 160 of the secondary device 110. Additionally, audio captured via the secondary device's microphone 165 may be encoded and transmitted to the primary device 105 over the communication channel 175 established between the primary device 105 and the secondary device 110. Additionally, the primary device's microphone 165 may be deactivated from the phone application 150. Accordingly, phone call audio is transferred to the secondary device 110, where the second user is able to continue a conversation with a user of the endpoint communication device 120. In some implementations, an “ignore” or “reject” option may be included in the call transfer request notification, which prevents a communication channel 175 from being established between the primary device 105 and the secondary device 110.

In some examples, one or more call control options are displayed on a screen of the secondary device 110. For instance, the call control options may correspond to various actions, such as an option to end the phone call 130, an option to transfer the phone call 130 back to the primary device 105, an option to mute the secondary device's microphone 165, and/or other control option actions. In some implementations, if the call control option to transfer the phone call 130 back to the primary device 105 is selected, the wireless communication channel 175 established between the primary device 105 and the secondary device 110 may be terminated. In other implementations, when a call control option is selected, a signal is sent to the primary device 105, which then carries out the corresponding action. For instance, if a call control option to end the phone call 130 is selected, a signal may be sent to the primary device 105, which then ends the phone call 130 with the endpoint communication device 120.

In some examples, the wireless communication channel 175 between the primary device 105 and the secondary device 110 is a Bluetooth communication link. When the Bluetooth communication link is established, audio data of the phone call 130 from the endpoint communication device 120 is received by the phone application 150 operating on the primary device 105 and transmitted via the Bluetooth communication link to the secondary device 110. The audio data is then output by the speaker 160 on the secondary device 110 or by another output interface. Additionally, audio data received as input from the second user via the microphone 165 of the secondary device 110 is transmitted to the primary device 105 via the Bluetooth communication link and then transmitted to the endpoint communication device 120.

In other examples, the wireless communication channel 175 is a peer-to-peer communication link over a LAN. For instance, audio data of the active phone call 130 from the endpoint communication device 120 is received by the phone application 150 of the primary device 105, which is then transmitted to the phone application 150 on the secondary device 110 via the peer-to-peer communication link. Additionally, audio data received from the second user received as input via the microphone 165 of the secondary device 110 is transmitted to the phone application 150 on the primary device 105 via the peer-to-peer communication link. The second user's audio data is then transmitted to the endpoint communication device 120 as part of the active phone call 130 between the endpoint communication device 120 and the primary device 105.

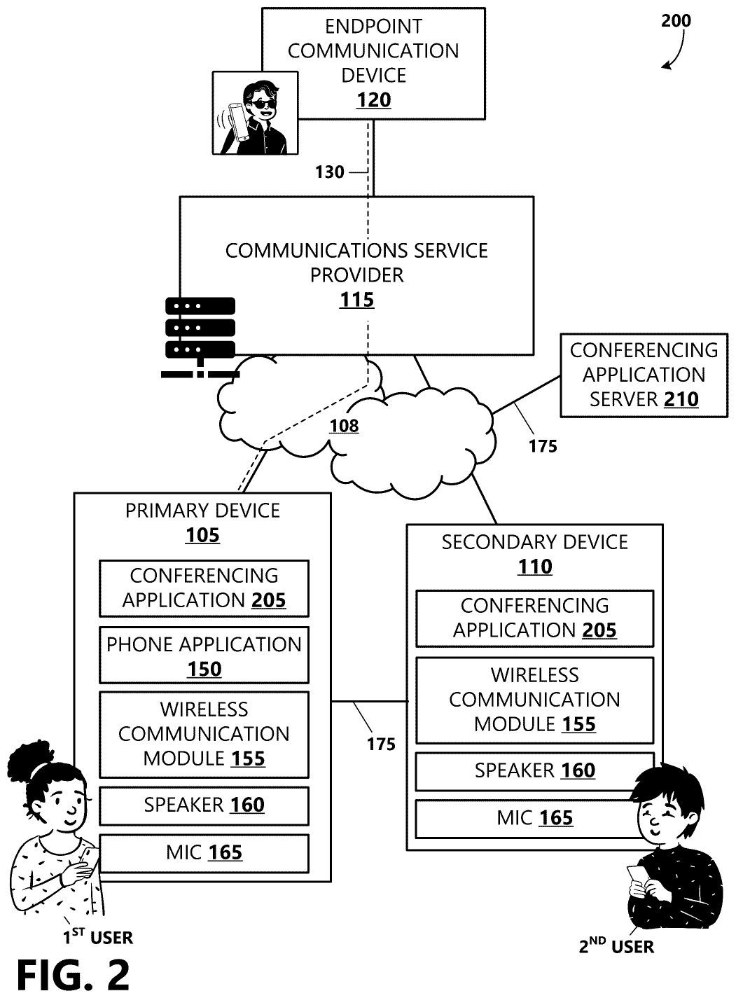

FIG. 2 is a representation of a communications system 200 in accordance with another illustrative aspect. The communications system 200 of FIG. 2 is substantially similar to the communications system 100 described above, but communications system 200 implements a conferencing application 205. For example, a first instance of the conferencing application 140 operates on the primary device 105 and a second instance of the conferencing application 140 operates on the secondary device 110. In some implementations, the first and second instances of the conferencing application 140 communicate via a peer-to-peer wireless communication channel 175. For instance, audio data of the phone call 130 from the endpoint communication device 120 is received by the phone application 150 of the primary device 105 and provided to the first instance of the conferencing application 140 operating on the primary device 105, which transmits the audio data to the second instance of the conferencing application 140 operating on the secondary device 110 via the peer-to-peer communication link. Additionally, audio data received as input from the second user via the microphone 165 of the secondary device 110 is transmitted by the second instance of the conferencing application 140 operating on the secondary device to the first instance of the conferencing application 140 operating on the primary device 105 via the peer-to-peer communication link. The second user's audio data is then provided to the phone application 150 operating on the primary device 105 and transmitted to the endpoint communication device 120 as part of the phone call 130 between the endpoint communication device 120 and the primary device 105. In other implementations, the wireless communication channel 175 between the primary device 105 and the secondary device 110 is established via communication between the first and second instances of the conferencing application 140 and a conferencing server 210 connected to the network 108. For instance, audio data may be transmitted between the primary device 105 and the secondary device 110 over the Internet.

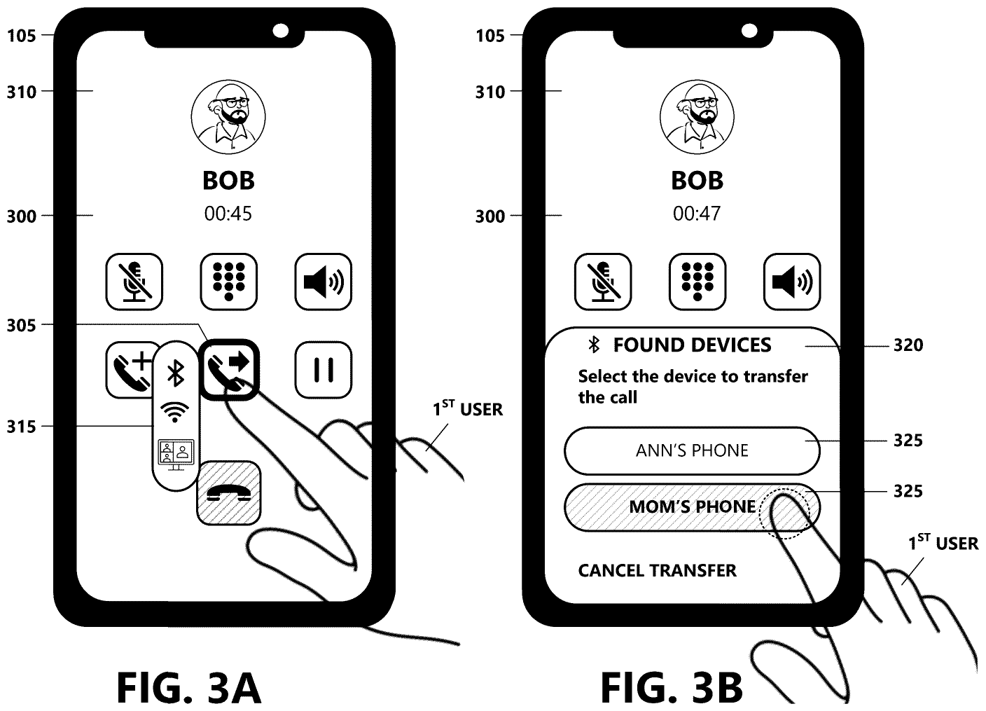

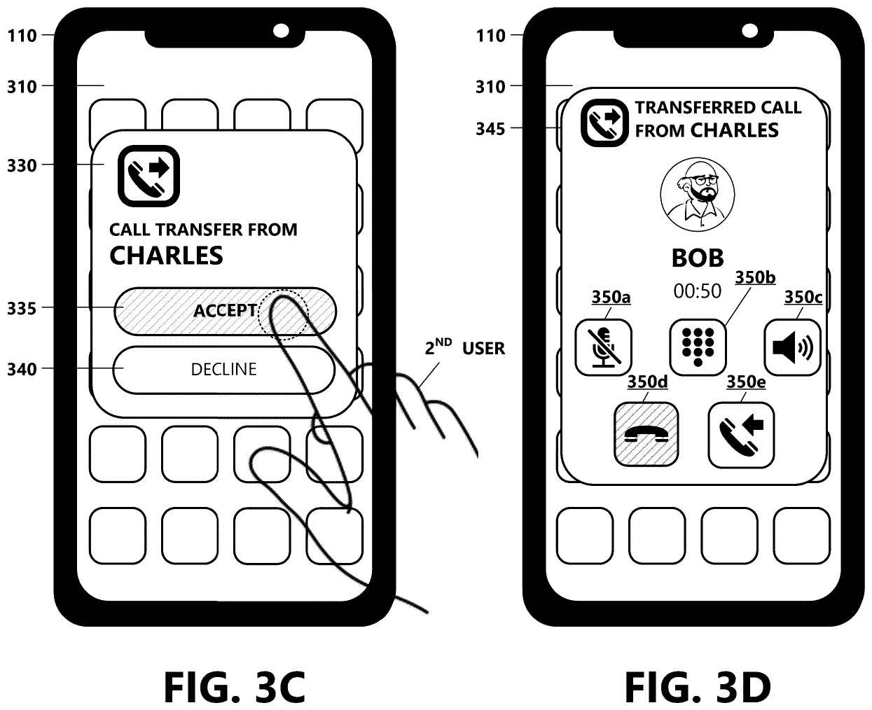

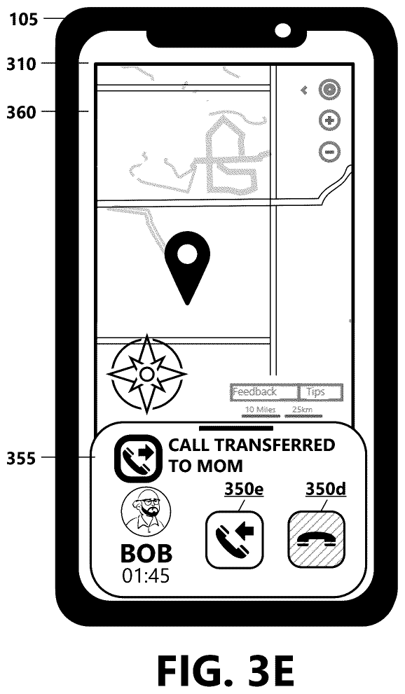

FIGS. 3A-3E depict example user interfaces that may be provided for transferring audio of a phone call 130 according to examples. With reference now to FIG. 3A, an example phone application user interface 300 is displayed on a screen 310 of the primary device 105. For instance, the first user of the primary device 105 may be on an active phone call 130 with a user “Bob” of an endpoint communication device 120. The first user may desire to transfer the call with Bob to a second user of a secondary device 110. As depicted in FIG. 3A, the first user may select a call transfer option 305 included in the phone application user interface 300. In other implementations, the call transfer option 305 may be presented and selected in other ways. In some examples, one or more sub-options 315 corresponding to different transfer or connection options (e.g., transfer via Bluetooth, transfer via Wi-Fi, transfer via peer-to-peer, transfer via a separate application) may be presented from which the first user may select.

With reference now to FIG. 3B, a first example call transfer user interface 320 is displayed on a screen 310 of the primary device 105. For instance, the first call transfer user interface 320 may be presented upon receiving a selection of the call transfer option 305. In some implementations, the primary device 105 searches for nearby devices to which audio of the phone call 130 may be transferred and presents one or more secondary device options 325 in the first call transfer user interface 320 corresponding to one or more identified devices. Selection of a secondary device option 325 may trigger a call transfer request to be transmitted to the corresponding secondary device 110 (e.g., “Mom's phone”).

With reference now to FIG. 3C, a second example call transfer user interface 330 is displayed on a screen 310 of the secondary device 110. For instance, the second call transfer user interface 330 may be a call transfer request notification presented by the secondary device 110 upon receiving the call transfer request. In examples, the call transfer request notification includes an accept option 335 that allows the second user to accept the call transfer if desired. In further examples, the call transfer request notification includes a decline option 340 that allows the second user to decline the call transfer if desired. As depicted in FIG. 3C, the second user selects the accept option 335, which causes audio of the phone call 130 to be bridged to the secondary device 110. In examples, received audio data may be output by the secondary device's speaker 160. Additionally, the secondary device's microphone 165 may be activated to capture audio input from the second user to transmit to the primary device 110 for further transmission to the endpoint communication device 120.

In some implementations, and as depicted in FIG. 3D, a third example call transfer user interface 345 may be displayed by the secondary device 110. For instance, the third call transfer user interface 345 may include one or more call control options 350a-350e (collectively, call control options 350). The call control options 350 may correspond to various actions. For instance, a first call control option 350a may correspond to a mute/unmute action, a second call control option 350b may correspond to displaying a phone keypad, a third call control option 350c may correspond to selecting a desired speaker 160 of the secondary device 110, a fourth call control option 350d may correspond to ending the phone call 130, and a fifth call control option 350e may correspond to transferring the phone call 130 back to the primary device 105. Additional or alternative call control options 350 are contemplated.

With reference now to FIG. 3E, a fourth example call transfer user interface 355 is displayed by the primary device 105. In some implementations, a user interface 360 of another active application on the primary device 105 may be displayed in the background and the fourth call transfer user interface 355 may be displayed as a partial overlay. In other implementations, the fourth call transfer user interface 355 is maximized on the screen 310. In yet other implementations, the fourth call transfer user interface 355 may be minimized or hidden. The fourth call transfer user interface 355 may include various call control options 350 corresponding to various actions. For instance, the fourth call transfer user interface 355 may include the fourth call control option 350d corresponding to ending the phone call 130 and the fifth call control option 350e corresponding to transferring the phone call 130 back from the secondary device 110. Additional or alternative call control options 350 are contemplated.

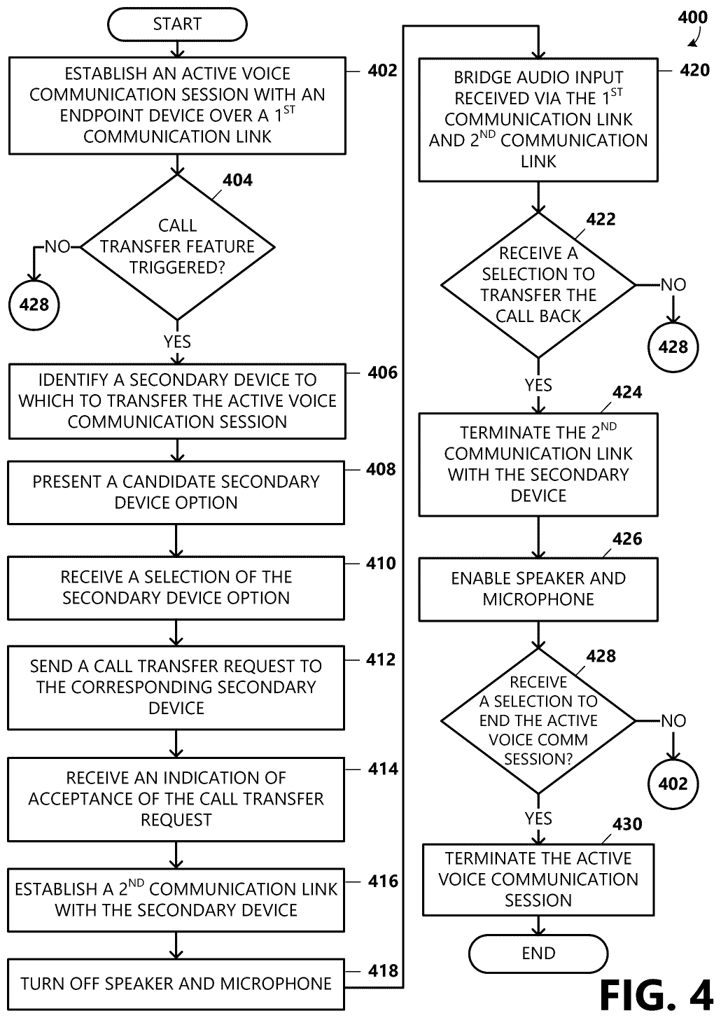

FIG. 4 depicts an example method 400 for transferring audio of a phone call 130 from a primary device 105 to a secondary device 110. For example, the operations of method 400 are performed by the primary device 105 to provide transfer of phone call audio. At operation 402, a first user of the primary device 105 is engaged in the phone call 130 with a user of an endpoint communication device 120 (e.g., a mobile phone, a landline phone, or a VOIP phone). In examples, the phone call 130 between the primary device 105 and the endpoint communication device 120 is over a first communication link that may be established via various communication technologies (e.g., a cellular, Wi-Fi, VOIP).

At decision operation 404 a determination may be made as to whether the call transfer feature has been triggered. For instance, the first user may wish to transfer audio of the phone call 130 to another device and may select a call transfer option, such as the example call transfer option 305 depicted in FIG. 3A. In other examples, the call transfer option is received as a spoken command, gesture, or other user input. In yet other examples, the call transfer feature is triggered by the secondary device 110. For instance, a second user may select a call transfer request option on the secondary device 110 that causes a signal to be transmitted to the primary device 105, triggering the call transfer feature. In some examples, a call transfer sub-option 315 corresponding to a particular connection/transfer option (e.g., transfer via Bluetooth, transfer via Wi-Fi, transfer via a peer-to-peer link, transfer via another application) may be additionally selected by the first user. When another application (e.g., a conferencing application 205) is selected for transferring audio of the phone call 130, the application may be opened and a connection may be made with a corresponding application server (e.g., conferencing application server 210). In other examples, a particular connection/transfer option is preselected via a settings option.

When the call transfer feature is triggered, the method 400 proceeds to operation 406, where a device (i.e., the secondary device 110) is identified as a candidate device to which to transfer the phone call 130. In some examples, the secondary device 110 is identified based on a selected connection/transfer option. In further examples, more than one device is identified. In one example, the secondary device 110 corresponds to a device previously paired and connected with the primary device 105. In another example, the secondary device 110 corresponds to a device in discovery mode that allows the device to be detected by the primary device 105 through various wireless communication protocols, such as Bluetooth, NFC, Wi-Fi, among others. In another example, the secondary device 110 corresponds to a device that triggered the call transfer feature on the primary device 105. In yet another example, the secondary device 110 corresponds to a device in the first user's contacts list. In a further example, the secondary device 110 corresponds to a device to which the primary device 105 last or previously transferred a prior phone call.

A secondary device option 325 corresponding to the secondary device 110 may be presented by the primary device 105 at operation 408. At operation 410, the secondary device option 325 is selected by the first user. At operation 412, a call transfer request may be sent to the secondary device 110. In some examples, the call transfer request is sent via a Bluetooth or peer-to-peer pairing request. In other examples, the call transfer request is sent via the conferencing application server 210.

In examples, a call transfer request notification may be displayed by the secondary device 110 in a user interface (e.g., second example call transfer user interface 330) and may include an accept option 335 that may be selected to accept the call transfer. At operation 414, and indication of acceptance of the call transfer request is received. At operation 416, a second communication link is established between the primary device 105 and the secondary device 110. In some examples, the second communication link is a Bluetooth link. In other examples, the second communication link is a peer-to-peer communication link. In yet other examples, the second communication link is a server-mediated connection, where the primary device 105 and the secondary device 110 communicate with each other through the conferencing application server 210.

At operation 418, the speaker 160 and microphone 165 of the primary device 105 are deactivated for the phone application 150. For instance, audio of the phone call 130 may not be played on the primary device's speaker 160 and the phone application 150 may not access the microphone 165 on the primary device 105 to receive audio input. However, the primary device's speaker 160 and microphone 165 may remain functional for other applications on the primary device 105.

At operation 420, audio data received on the phone call 130 via the first communication link may be bridged to the secondary device 110 over the second communication link. In examples, the received audio data may be output by the secondary device's speaker 160 (or another speaker actively connected to the secondary device 110). Further, the secondary device's microphone 165 (or another microphone actively connected to the secondary device 110) may be activated to capture audio input. Captured audio data may be transmitted to the primary device 105 via the second communication link. The primary device 105 may then transmit the captured audio data to the endpoint communication device 120 via the first communication link. In some examples, such as when the conferencing application 205 is used to establish the second communication link with the secondary device 110, audio data received from the endpoint communication device 120 may be provided by the phone application 150 to the conferencing application 205 to transmit to the secondary device 110. Additionally, audio data captured by the secondary device 110 may be communicated to and then received by the conferencing application 205 on the primary device 105, which then provides the captured audio data to the phone application 150 to transmit to the endpoint communication device 120.

In some implementations, a user interface, such as the third example call transfer user interface 345 depicted in FIG. 3D, may be provided to and displayed by the secondary device 110, where the user interface may include one or more call control options 350 corresponding to various phone call actions. In some examples, a selection of a call control option 350 on the secondary device 110 is communicated to the primary device 105 via the second communication link, which executes the corresponding action.

At decision operation 422, a determination is made as to whether an indication of a selection is received to transfer audio of the phone call 130 back to the primary device 105. In some examples, a selection to transfer audio of the phone call 130 back to the primary device 105 is received by the primary device 105. For instance, a call control option 350 corresponding to ending the call transfer, such as the example fifth call control option 350e depicted in FIG. 3E, may be presented in a user interface on the primary device 105 and selected by the first user. In other examples, a selection to transfer audio of the phone call 130 back to the primary device 105 is received by the secondary device 110 and communicated to the primary device 105. For instance, the example fifth call control option 350e depicted in FIG. 3D may be presented in a user interface on the secondary device 110 and selected by the second user.

When a selection to transfer audio of the phone call 130 back to the primary device 105 is received, the method 400 proceeds to operation 424, where the second communication link with the secondary device 110 may be terminated. At operation 426, the primary device's speaker 160 and microphone 165 may be reactivated for the phone application 150 on the primary device 105. Thus, audio data received from the endpoint communication device 120 may be played via the primary device's speaker 160 and audio input received via the primary device's microphone 165 may be transmitted to the endpoint communication device 120 via the first communication link.

At decision operation 428, a determination is made as to whether a selection to end the phone call 130 is received. In some examples, a selection to end the phone call 130 is received from the primary device 105. For instance, a call control option 350 corresponding to ending the phone call 130 (e.g., the example fourth call control option 350d depicted in FIG. 3E) may be presented in a user interface on the primary device 105 and selected by the first user. In other examples, a selection to end the phone call 130 is received by the secondary device 110 and communicated to the primary device 105. For instance, when a selection to transfer the phone call 130 back to the primary device 105 is not received at decision operation 422, a call control option 350 (e.g., the example fourth call control option 350d depicted in FIG. 3D) may be presented in a user interface on the secondary device 110 and selected by the second user.

When a selection to end the phone call 130 is received, the method 400 proceeds to operation 430, where the phone call 130 is terminated. For instance, the first communication link between the primary device 105 and the endpoint communication device 120 may be discontinued. Additionally, the second communication link between the primary device 105 and the secondary device 110 may be discontinued and the method 400 may end. When a selection to end the phone call 130 is not received at decision operation 428, the method 400 may return to operation 402.

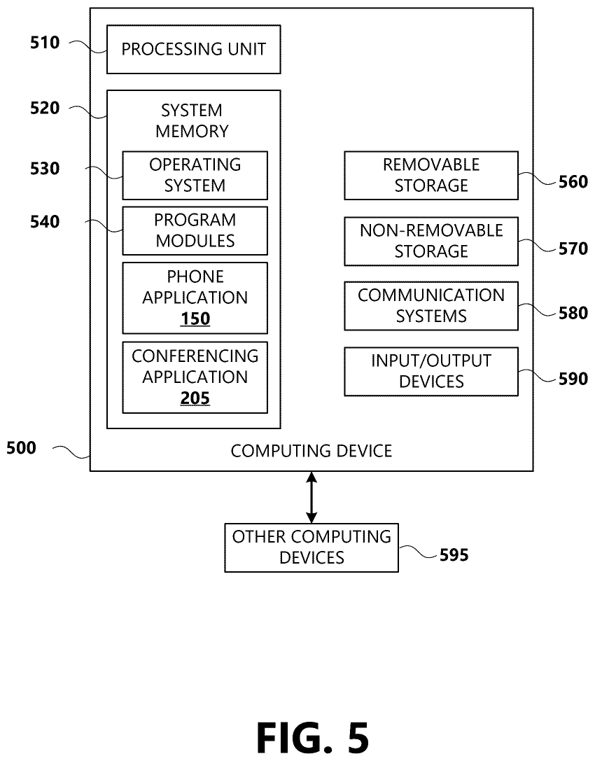

FIG. 5 is a system diagram of a computing device 500 according to an example. The computing device 500, or various components and systems of the computing device 500, may be integrated or associated with one or more components of the communication system 100 or communication system 200. As shown in FIG. 5, the physical components (e.g., hardware) of the computing device 500 are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for performing one more of the operations of the method 400 described above for providing phone call audio transfer. A number of different program modules and data files may be stored in the system memory 520. While executing on the processing unit 510, the program modules 540 may perform the various processes described above. One example program module 540 includes the phone application 150. Another example program module 540 includes the conferencing application 205.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 such as, for example, routing engines, gateways, signings systems and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system, comprising:
at least one processing unit; and
memory, operatively connected to the at least one processing unit and storing instructions that, when executed by the at least one processing unit, cause the system to:
on a primary mobile communication device, establish an active voice communication session with an endpoint communication device via a first communication link;
receive a selection, during the active voice communication session, to transfer audio of the active voice communication session to a secondary mobile communication device;
provide a call transfer request to the secondary mobile communication device;
receive an indication of approval of the call transfer request;
establish a second communication link between the primary mobile communication device and the secondary mobile communication device;
deactivate, during the active voice communication session, a microphone and speaker for the active voice communication session on the primary mobile communication device;
relay, by the primary mobile communication device, audio data received during the active voice communication session from the endpoint communication device via the first communication link to the secondary mobile communication device via the second communication link; and
relay, by the primary mobile communication device, audio data received during the active voice communication session from the secondary mobile communication device via the second communication link to the endpoint mobile device via the first communication link.

2. The system of claim 1, wherein the selection to transfer audio of the active voice communication session the secondary device comprises:
presenting a call transfer option; and
receiving a selection of the call transfer option.

3. The system of claim 2, further comprising:
presenting an option corresponding to the secondary mobile communication device; and
receiving a selection of the secondary mobile communication device.

4. The system of claim 3, further comprising identifying the secondary mobile communication device.

5. The system of claim 4, wherein in identifying the secondary mobile communication device, the instructions cause the system to detect the secondary mobile communication device, wherein the secondary mobile communication device is at least one of:
a device previously paired and connected to the primary mobile communication device; or
a device in discovery mode.

6. The system of claim 1, wherein the second communication link is a Bluetooth communication link.

7. The system of claim 1, wherein the second communication link is a peer-to-peer communication link.

8. The system of claim 1, wherein the second communication link is a server-moderated communication link.

9. The system of claim 1, wherein the instructions further cause the system to:
provide a first call control option for the second mobile communication device to display;
provide a second call control option for display by the primary mobile communication device; and
receive an indication of a selection of the first or second call control option.

10. The system of claim 9, wherein the first and second call control options are options to transfer audio of the phone call back to the primary device; and
the instructions further cause the system to:
terminate the second communication link; and
reactivate the microphone and speaker of the primary communication device for the active voice communication session.

11. The system of claim 9, wherein:
the first and second call control options are options to end the active voice communication session; and
the instructions further cause the system to:
terminate the first communication link; and
terminate the second communication link.

12. The system of claim 1, wherein:
the selection to transfer audio of the active voice communication session to the secondary mobile communication device includes a selection to use a conferencing application;
in relaying audio data to the secondary mobile communication device, the instructions cause the system to provide audio data received from the endpoint device to a first instance of the conferencing application on the primary mobile communication device for relay to a second instance of the conferencing application on the secondary mobile communication device via the second communication link; and
in relaying audio data to the endpoint device, the instructions cause the system to provide audio data received from the second instance of the conferencing application on the secondary mobile communication device to a first instance of the conferencing application on the primary mobile communication device for relay to the endpoint device via the first communication link.

13. A method, comprising:
on a primary mobile communication device, establishing an active voice communication session with an endpoint communication device via a first communication link;
receiving a selection, during the active voice communication session, to transfer audio of the active voice communication session to a secondary mobile communication device;
providing a call transfer request to the secondary mobile communication device;
receiving an indication of approval of the call transfer request;
establishing a second communication link between the primary mobile communication device and the secondary mobile communication device;
deactivating, during the active voice communication session, a microphone and speaker for the active voice communication session on the primary mobile communication device;
relaying, by the primary mobile communication device, audio data received during the active voice communication session from the endpoint communication device via the first communication link to the secondary mobile communication device via the second communication link; and
relaying, by the primary mobile communication device, audio data received during the active voice communication session from the secondary mobile communication device via the second communication link to the endpoint mobile device via the first communication link.

14. The method of claim 13, wherein receiving the selection to transfer audio of the active voice communication session to the secondary mobile communication device comprises:
presenting a call transfer option;
receiving a selection of the call transfer option;
presenting an option corresponding to the secondary mobile communication device; and
receiving a selection of the secondary mobile communication device.

15. The method of claim 14, wherein presenting the option corresponding to the secondary mobile communication device further comprises identifying the secondary mobile communication device.

16. The method of claim 15, wherein identifying the secondary mobile communication device comprises detecting the secondary mobile communication device, wherein the secondary mobile communication device is at least one of:
a device previously paired and connected to the primary mobile communication device; or
a device in discovery mode.

17. The method of claim 13, wherein establishing the second communication link comprises one of:
establishing a Bluetooth communication link;
establishing a peer-to-peer communication link; or
establishing a server-moderated communication link.

18. The method of claim 13, further comprising:
providing a first call control option for the second mobile communication device to display;
providing a second call control option for display by the primary mobile communication device; and
receiving an indication of a selection of the first or second call control option, wherein:
the first and second call control options are options to transfer audio of the active voice communication session back to the primary device and further comprising:
terminating the second communication link; and
reactivating the microphone and speaker of the primary communication device for the active voice communication session; or
the first and second call control options are options to end the active voice communication session and further comprising:
terminating the first communication link; and
terminating the second communication link.

19. The method of claim 13, wherein:
receiving the selection to transfer audio of the active voice communication session to the secondary mobile communication device includes receiving a selection to use a conferencing application;
relaying audio data to the secondary mobile communication device comprises providing audio data received from the endpoint device to a first instance of the conferencing application on the primary mobile communication device for relay to a second instance of the conferencing application on the secondary mobile communication device via the second communication link; and
relaying audio data to the endpoint device comprises providing audio data received from the second instance of the conferencing application on the secondary mobile communication device to a first instance of the conferencing application on the primary mobile communication device for relay to the endpoint device via the first communication link.

20. A non-transitory computer-readable medium, storing instructions that, when executed by a computing device, cause the computing device to:
establish an active voice communication session between a primary mobile communication device and an endpoint communication device via a first communication link;
receive a selection, during the active voice communication session, to transfer audio of the active voice communication session to a secondary mobile communication device;
provide a call transfer request to the secondary mobile communication device;
receive an indication of approval of the call transfer request;
establish a second communication link between the primary mobile communication device and the secondary mobile communication device;
deactivate, during the active voice communication session, a microphone and speaker for the phone call on the primary mobile communication device;
relay, by the primary mobile communication device, audio data received during the active voice communication session from the endpoint communication device via the first communication link to the secondary mobile communication device via the second communication link; and
relay, by the primary mobile communication device, audio data received during the active voice communication session from the secondary mobile communication device via the second communication link to the endpoint mobile device via the first communication link.
